(19) United States
(12) Patent Application Publication
(10) Pub. No.: US 2002/0136623 A1
(43) Pub. Date: Sep. 26, 2002

(54) Vehicle to provide for handicapped seating in wheelchairs

(76) Inventor: William Bauers, Las Vegas, NV (US)

Correspondence Address: Anderson & Morishita, L.L.C., 2725 South Jones Blvd, Suite 102, Las Vegas, NV, 89146, US

(21) Appl. No.: 09/802,355

(22) Filed: Mar. 9, 2001

(51) Int. Cl. B60P 1/00

(52) U.S. Cl. 414/537

(57) ABSTRACT

A system is set forth for locating a handicapped individual in a vehicle compartment. In one embodiment, a seat is mounted on telescoping rails to telescope outside of the vehicle to seat the individual. The seat is thereafter pushed as guided by the rails to the stowed position inside the vehicle. In another embodiment, a ramp is provided for rolling a wheelchair-bound individual onto a turntable in the vehicle. The individual while still in the wheelchair is secured to the turntable and the turntable is fixed inside the compartment.

### FIELD OF THE INVENTION

The present invention relates to devices to accommodate ingress and egress of into and out of vehicles.

### BACKGROUND

Typically handicapped persons in wheelchairs have had to exit their wheelchairs to occupy a vehicle such as a van, automobile or limousine. This can be difficult and strenuous for the handicapped person.

Along these same lines, it may be difficult for handicapped persons and others, such as brides wearing gowns and the like, to seat themselves such a van, automobile or limousine. They must stoop to enter the vehicle and then turn around and position themselves in the seat. This can be difficult due to a physical handicap, the clothing being worn or simply due to the effort required.

There is, accordingly, a need for a vehicle which can accommodate handicapped individuals and others who also have difficulty or it is inconvenient to enter the vehicle prior to taking one seats.

### SUMMARY OF THE INVENTION

There is therefore set forth according to the present invention systems to accommodate positioning a handicapped individual into a vehicle for transportation thereof. In one embodiment, a seat is mounted on telescoping rails to telescope the seat from a stowed position inside the vehicle to a position through the door to the outside of the vehicle. From the stowed position, the vehicle's door is opened and the seat is telescoped to move the seat to an expended position outside of the vehicle. If desired the seat itself may be rotatably mounted on the rails. The seat in the extended position is rotated and the handicapped individual is seated in the seat and buckled in place. The seat, positioned to face forwardly with respect to the vehicle, is moved as guided by collapsing of the telescoping rails, back to the stowed position. In the stowed position the seat is pinned or otherwise fixed against movement.

In another embodiment, a turntable is provided in the vehicle compartment to receive a wheelchair. A ramp is provided for rolling of the wheelchair up the ramp and onto the turntable. The turntable is rotated to face the individual forward and the turntable is fixed in position. The wheelchair is chocked and the individual is buckled in place.

In either embodiment, the vehicle may be provided with a hydraulic raising and lowering system to raise and lower the vehicle compartment for reception of the individual.

### BRIEF DESCRIPTION OF THE DRAWINGS

FIG. 1 is a top perspective view of a vehicle shown as a limousine incorporating the system and method of the present invention;

FIG. 2 is a side view of a portion of the vehicle of FIG. 1 showing entry into the vehicle for a person occupying a wheelchair;

FIG. 3 is a top view of a portion of the vehicle of FIG. 2 showing a turntable for the person occupying the wheelchair;

FIG. 4 is a side view showing a wheelchair positioned on the turntable prior to rotation of the turntable to face forward;

FIG. 5 is a illustration of an hydraulic system for raising and lowering the vehicle to accept the wheelchair;

FIG. 6 is a top view of a portion of a vehicle including a further embodiment of means and a method for accommodating a handicapped individual or other individual who may have trouble entering the vehicle into the seat; and

FIG. 7 is a side view of a portion of a seat of FIG. 6.

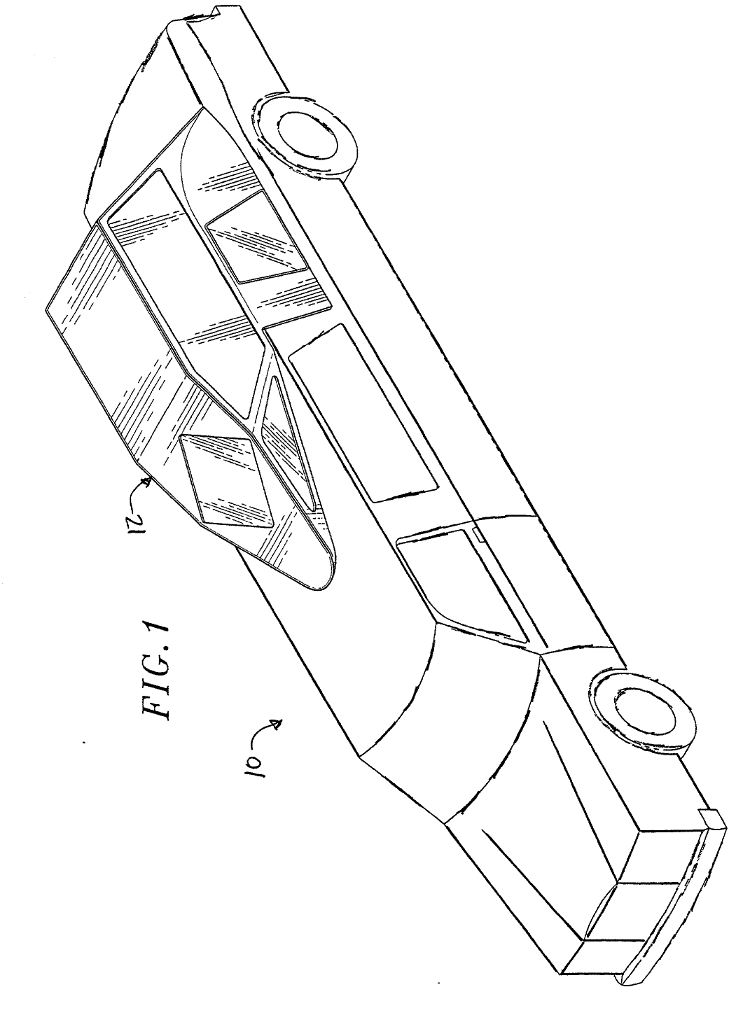

### DESCRIPTION

Turning to the drawings, a vehicle 10 is shown which includes the system and method according to the present invention. The vehicle in 10 may include a roof extension 12 to raise the roof and accommodate an individual in a wheelchair. Alternatively, the vehicle can include the system and method of the present invention and not require the extension 12. Furthermore, it is to understood that the vehicle, while shown as a limousine, could be a van, automobile, truck, bus or the like.

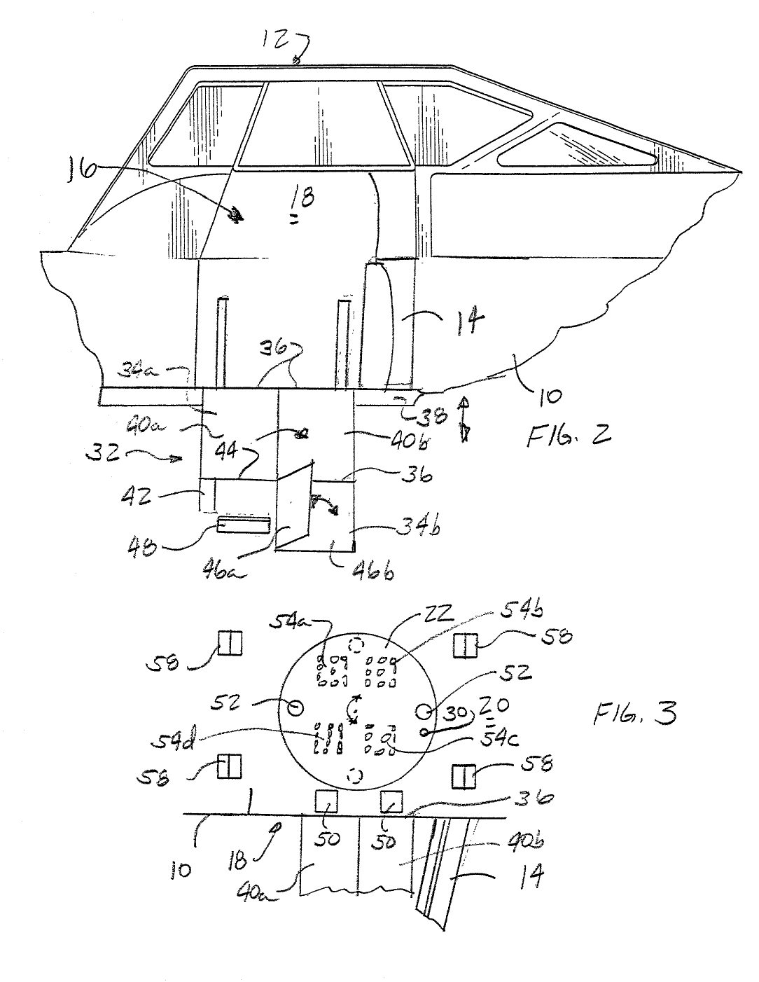

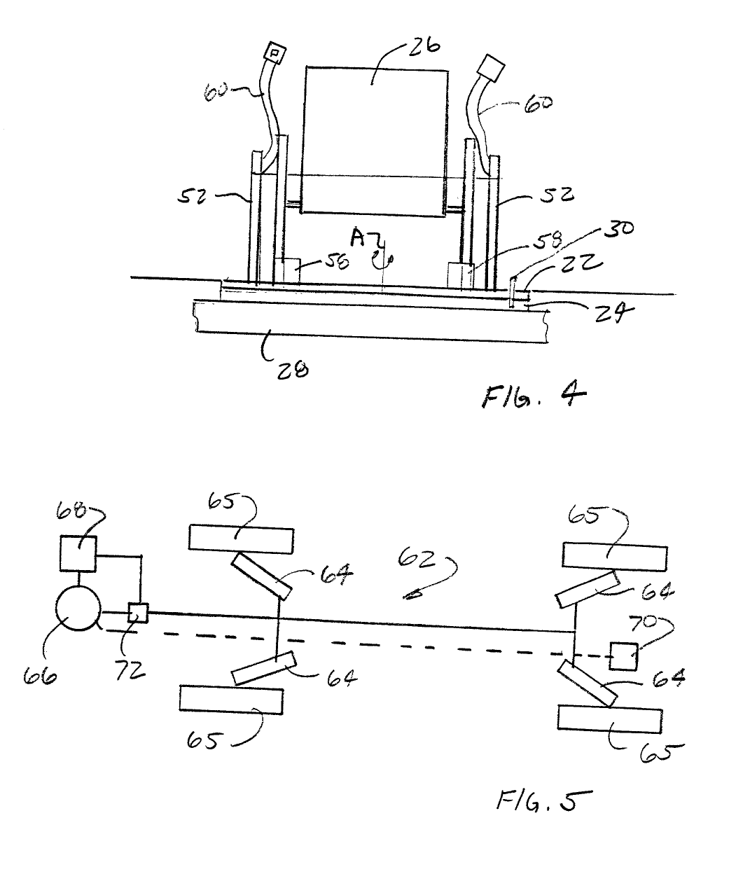

Turning to FIGS. 2 and 3, at at least one side of the vehicle 10 there is included a door 14 for the individual to enter and leave the cabin 16. When the door 14 is open, an opening 18 is defined for entry into and exit from the cabin 16 of the vehicle 10. Disposed in the floor 20 of the cabin 16 is a turntable 22 as best shown in FIG. 3. The turntable 22, with reference to FIG. 4, is journalled over a support plate 24 for rotation about an axis A for turning the person occupying a wheelchair 26 from a side facing direction to a forward facing direction as hereinafter described. The support plate 24, in turn, may be fastened to a support beam 28 for the vehicle 10. A pin 30 couples the turntable 22 to the support plate 24 to prevent rotation of the turntable 22.

To provide for a person in a wheelchair to enter the vehicle 10 through the opening 18 and become positioned on the turntable 22, the system and method includes a ramp structure 32 including portable upper and lower ramp segments 34a,b. The upper ramp segment 34a has a forward edge 36 adapted to couple to the running board 38 of the vehicle 10 when the door 14 is opened as shown in FIG. 2. The upper ramp segment 34a includes two upper panels 40a,b which are coupled by a hinge, not shown, so that they may be folded for storage in the trunk of the vehicle 10. When unfolded, the upper panels 40a,b present the upper ramp segment 34a.

Opposite the forward edge 36 of the upper ramp segment 34a, legs 42 are provided to support a trailing edge 44 for the upper ramp segment 34a above the ground. The lower ramp segment 34b is likewise hinged by hinges (not shown) and includes lower panels 46a,b. As illustrated in FIG. 2, the lower panels 46a,b like the upper panels 40a,b, may be folded together for storage into the trunk of the vehicle 10. A forward edge 36 of the lower ramp segment 34b couples to the trailing edge 44 of the upper ramp segment 34a whereas the trailing edge 44 of the lower ramp segment 34b rests on the ground. To support the lower panels 46a,b, portable support blocks 48 may be deployed prior to unfolding the lower panels 46a,b.

As can be appreciated, when the upper and lower ramp segments 34a,b are unfolded and deployed, the ramp 32 is defined to pass and guide an individual in a wheelchair up to and through the opening 18 into the cabin 16 of the vehicle.

As shown in FIG. 3, at the floor 20 of the vehicle, between the turntable 22 and ramp 32, spaced traction surfaces 50 may be provided to give added traction between the wheels of the wheelchair and the floor 20 of the vehicle 10, which may be carpeted. An individual in a wheelchair is urged up the ramp 32 through the opening 18 into the cabin 16 to become positioned on the turntable 22 as shown in FIG. 4.

With reference to FIG. 3, the turntable is provided with a pair of spaced and removable support posts 52 adapted to be removably connected and to upstand from the turntable 22. The support posts 52 are diametrically opposed on the turntable 22 and upstand therefrom somewhat corresponding to the diameter of the wheels of the wheelchair. The turntable 22 also includes spaced hole patterns 54a-d positioned to reside forward and aft of the wheels 56 of a wheelchair 26 disposed on the turntable 22. Chocks 58 are provided and include pins received in the holes of the hole patterns 54a-d for chocking the wheels of the wheelchair 26 when positioned on the turntable 22.

With reference to FIGS. 2-4, when it is desired to receive a person in a wheelchair into the vehicle 10, the door 14 is opened and the upper and lower ramp segment 34a,b are removed from the trunk. The upper panels 40a,b for the ramp 32 are deployed with the forward edge 36 thereof engaging the running board 38 for the vehicle 10 and the legs 42 positioned to support the upper ramp segment 34a. Thereafter the lower panels 46a,b are unfolded, deployed and connected to the upper ramp segment 34a as well as supported by the support blocks 48. In this position, the upper and lower ramp segments 34a,b define the ramp 32. The individual in the wheelchair 26 is rolled up the ramp 32 onto the turntable 22 between the support posts 52 as shown in FIG. 4. The chocks 58 are pinned to the turntable 22 by inserting pins in the holes of the hole patterns 54a-d to chock the wheels of the wheelchair. Thereafter a seatbelt 60 connected to the support post 52 is extended about the individual in the wheelchair 26 and secured. If desired, strapping (not shown) may be extended between the support posts 52 and the wheelchair wheels 56 to further secure the wheelchair 26 to the turntable 22. The pin 30 is pulled to release the turntable 22 from the support plate 24, and the turntable 22 is rotated about axis A to turn the individual in the wheelchair 26 from a side facing position to a forward facing position. The phantom lines in FIG. 3 show the position of the support posts 52 when the turntable 22 is thusly rotated. The pin 30 is re-inserted to fix the turntable 22 relative to the support plate 24 in the forward facing direction. The ramp 32 is disassembled and returned to the trunk of the vehicle 10 and the door 14 is closed. In this position, the individual in the wheelchair 26 is supported on the turntable 22 in the cabin 16 in a forward directed position. As can be appreciated, the vehicle 10 can easily accommodate an individual in a wheelchair without the individual having to get out of the wheelchair.

Turning to FIG. 5, if desired or required, the vehicle 10 may be provided with a hydraulic lowering system 62 including hydraulic lifts 64 disposed proximate each wheel 65 for the vehicle 10 for raising and lower the vehicle 10 relative to the ground. A hydraulic pump 66 disposed in the trunk of the vehicle 10 and pumping hydraulic fluid from a reservoir 68 supplies pressurized fluid to the hydraulic lifts 64. The pump 66 is powered from the vehicle's battery 70 by a suitable electric connection. A control valve 72 controls the supply and release of hydraulic fluid to the hydraulic lifts 64. Accordingly, to lower the vehicle, hydraulic fluid is vented from the hydraulic lifts 64 by the control valve 72, the fluid vented back to the reservoir 68. When lowered, the ramp 32 may be deployed to receive an individual in a wheelchair 26. After the individual has been positioned in the cabin 16 as described above, and the ramp disassembled and stowed, the control valve 72 is operated to supply pressurized hydraulic fluid to the hydraulic lifts 64 to raise the vehicle for operation thereof.

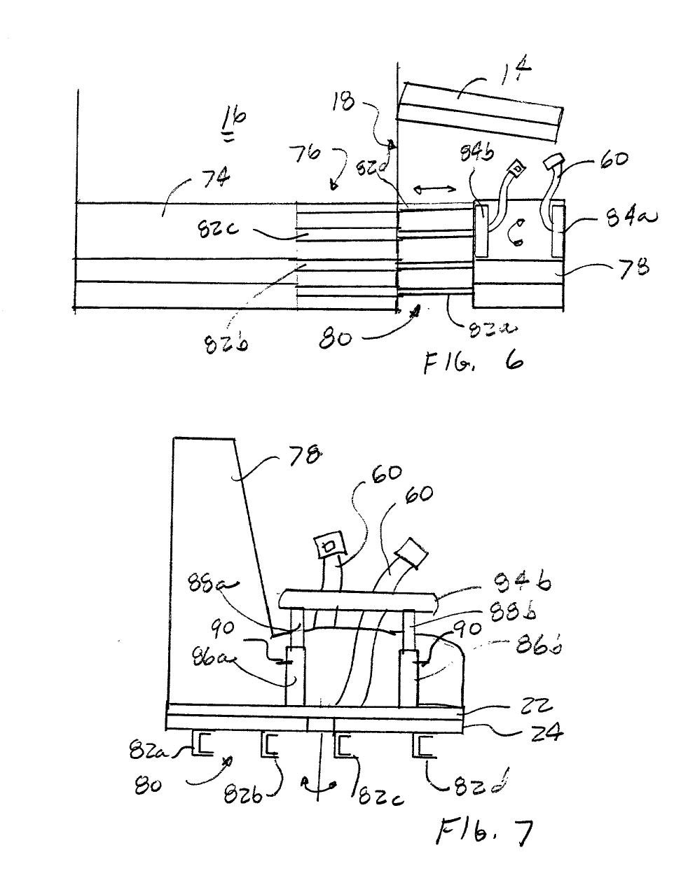

Turning to FIGS. 6 and 7, another embodiment of the present invention is shown. Accordingly to this embodiment, the cabin 16 includes a bench seat 74 which terminates short of the opening 18 to define a recess 76 to receive a removable chair 78. The chair 78 is mounted on a turntable 22 supported upon a support plate 24 for rotation about an axis A as hereinafter described. With reference to FIG. 6, the turntable 22 may be rotated from a forward directed position as shown in FIG. 6 to a side directed position, 90 degrees from the position shown in FIG. 6 to receive a passenger. One or more removable pins, not shown, are provided for securing the turntable 22 to the support plate 24 against rotation.

To provide for movement of the seat 74 into and out of the cabin 16, a carriage 80 is provided. The carriage 80 includes a plurality of telescoping rails 82a-d which are adapted to telescope into one another to permit the seat 74 to be positioned in the recess 76 and to extend from the vehicle 10 as shown in FIG. 6. When the seat 74 is moved on the carriage 80 into the recess 76, a suitable pin or locking device (not shown) is used to lock the seat 74 into position.

The seat 74 also includes a pair of removable arm rests, 84a,b. Sleeves 86a-d are disposed on either side of the seat 74 and are secured to the turntable 22. Rods 88a-d are adjustably received in the corresponding sleeves 86a-d with pairs thereof secured to the arm rests 84a,b. Pins 90, when the rods 88a-d are received in the sleeves 86a-d secure the rods 88a-d in position. A seatbelt 60 is secured to the turntable 22.

To position a handicapped person in the cabin 16 or to seat someone else who may be physically handicapped or who may be wearing a gown or the like in the vehicle 10, the seat 74 is released from the cabin 16 and slid outwardly through the opening 18 by the carriage 80 to an extended position as shown in FIG. 6. Thereafter, the turntable 22 is released from the support plate 24 and the seat 74 is rotated approximately 90 degrees to seat the individual standing outside the vehicle. The arm rests 84a,b may be removed form the seat 74. The person sits in the seat 74 and is buckled therein with the seat belt 60. The arm rests 84a,b are replaced and the seat 74 is swivelled by the turntable 22 to the forward facing position as shown in FIG. 6. The seat 74 containing the individual is then urged back into the cabin 16 with the rails 82a-d received one by the other in a telescoping fashion as the seat 74 is repositioned into the recess 76. The seat 74 is then pinned and fixed. The door 14 is closed and the vehicle 10 may be operated.

If desired, and accordingly to the embodiment of the invention shown in FIG. 6 and 7, the vehicle 10 may include the hydraulic lowering system 62 described above.

While I have disclosed and claimed certain embodiments of the present invention, it should be understood that the invention is subject to many variations and modifications without departing from the spirt and scope if the appended claims.

I claim:

1. A seat to accommodate seating a person in a vehicle compartment comprising:
a telescoping rail system disposed on said vehicle, said system having at one end thereof said seat, said rail system adapted to accommodate movement of the seat from a stowed position in the vehicle compartment to an extended position outside of the vehicle compartment in a position to seat said person, said rail system permitting the seat with the seated person to be moved to the stowed position in the compartment; and
means for locking the seat in said stowed position.

2. The seat of claim 1 further including a pivot to mount the seat to the rail system one end for rotating the seat relative to the said one end.

3. The seat of claim 2 further including means for securing the seat against rotation.

4. A system to accommodate reception and securing of a wheelchair-bound individual into a vehicle compartment having a door comprising:
a turntable rotatably disposed in the vehicle compartment, said turntable including a pair of upstanding support posts and a pattern of bores;
a ramp to direct the wheelchair in a forward or rearward direction up into the vehicle compartment from outside the vehicle and onto the turntable;
at least a plurality of chocks including a pins to be received in said bores to chock the wheels of te wheelchair on the turntable;
a seatbelt extended between said posts and about the individual; and
means for locking the turntable against rotation in a first position to receive the wheelchair and in a second position where the individual in the wheelchair on the turntable is facing forwardly.

5. The system of claim 4 further including a hydraulic system coupled to the vehicles suspension to lower the vehicle compartment to receive the individual.
